(19) United States
(12) Patent Application Publication
(10) Pub. No.: US 2025/0119956 A1
(43) Pub. Date: Apr. 10, 2025

(54) SIGNAL TRANSMISSION METHODS, DEVICES, AND STORAGE MEDIA

(71) Applicant: ZTE Corporation, Shenzhen (CN)

(72) Inventors: Qiujin GUO, Shenzhen (CN); Mengzhu CHEN, Shenzhen (CN); Bo DAI, Shenzhen (CN); Jun XU, Shenzhen (CN); Xuan MA, Shenzhen (CN); Hong TANG, Shenzhen (CN); Xiaoying MA, Shenzhen (CN); Youjun HU, Shenzhen (CN); Jianqiang DAI, Shenzhen (CN)

(21) Appl. No.: 18/984,906

(22) Filed: Dec. 17, 2024

Related U.S. Application Data
(63) Continuation of application No. PCT/CN2022/123323, filed on Sep. 30, 2022.

(51) Int. Cl. H04W 74/0833; H04W 74/00; H04W 74/08

(52) U.S. Cl. CPC H04W 74/0833; H04W 74/006; H04W 74/0891

(57) ABSTRACT

System and methods for signal transmission can include a wireless communication device receiving, from a wireless communication node, first information in a signaling indicative of a pattern of at least one physical random access channel (PRACH) or downlink (DL) signal transmission. The wireless communication device may transmit, to the wireless communication node, a PRACH signal corresponding to a DL signal index, in a random access (RA) occasion determined by the pattern.

### CROSS-REFERENCE TO RELATED APPLICATIONS

This application is a continuation of International Patent Application No. PCT/CN2022/123323, filed on Sep. 30, 2022, the disclosure of which is incorporated herein by reference in its entirety.

### TECHNICAL FIELD

The disclosure relates generally to wireless communications, including but not limited to systems, devices, methods and computer-readable media for signal transmission.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device may receive, from a wireless communication node, first information in a signaling indicative of a pattern of at least one physical random access channel (PRACH) or downlink (DL) signal transmission. The wireless communication device may transmit, to the wireless communication node, a PRACH signal corresponding to a DL signal index, in a random access (RA) occasion determined by the pattern.

The first information may comprise at least one of information of at least one paging occasion, information of at least one synchronization signal block (SSB), an indication of a number of RA occasions, an indication of a PRACH configuration period, an indication of an association period wherein the association period comprises a configured number of PRACH configuration periods, an indication of an association pattern period, an indication of a validity duration for a number of RACH occasions, an indication of a configured number of valid or available PRACH configuration periods, an indication of a time duration for the configured number of valid or available PRACH configuration periods, an indication of a time duration for a number of valid or available association periods, an indication of an offset to indicate a start position of a RA occasion, an indication of a start position of at least one of the validity duration for the number of RACH occasions, the time duration for the configured number of valid or available PRACH configuration periods, the time duration for the number of valid or available association periods, a PRACH occasion, the PRACH configuration period, the association period or the association pattern period.

At least a portion of the first information may be used to determine at least one valid or available RA occasion for transmission of the PRACH signal. The PRACH configuration period may satisfy at least one of (i) the PRACH configuration period is at most max_x milliseconds (ms) or at least min_x ms in length, wherein at least one of min_x is not larger than 10 ms or max_x is not smaller than 160 ms is satisfied, or (ii) a maximum value of a PRACH configuration index configured by higher layer signaling that is not less than M and not larger than M+α*n, wherein M is a positive integer and n is the number of PRACH configuration periods that are each larger than 160 ms. The parameter a may be a value in the range of 1 to 11 and the PRACH configuration period is configured for at least one of following preamble format: 0, 1, 2, 3, A1, A2, A3, B4, C0 or C2, or α may be a value in the range of 1 to 19 and the PRACH configuration period is configured for at least one of following preamble formats A1, A2, A3, B1, B4, C0, or C2, A1/B1, A2/B2 or A3/B3.

At least one of the following may be satisfied: the configured number of PRACH configuration periods is an integer in a defined set that is not less than n1 and not larger than n2, the PRACH configuration period (x) in milliseconds (ms) is an integer that is not smaller than min_x and not larger than max_x, wherein min_x is not larger than 10 or max_x is not smaller than 160, or n1 is not larger than 1 and n2 is not less than

$$\frac{max\_x}{min\_x} .$$

The association pattern period may include one or more association periods, and may be determined so that a pattern between RA occasions and SSB indices repeats at most every max_x or min_x*n2, or every T^{SSB} where T^{SSB} is a periodicity of a SSB and is larger than a maximum value of the association pattern period or the association period or the PRACH configuration period, or larger than 160 ms. PRACH occasions not associated with SSB indices after an integer number of association periods may not be used for PRACH transmission.

The SSB may comprise one or more synchronization signal and physical broadcast channel (SS/PBCH), a SSB with a large periodicity, or a small SSB. Cases where the PRACH configuration period is larger than 160 ms, or min_x or max_x is larger than 160 ms are triggered by at least one of the following events: the wireless communication device is configured to support a SSB different from a SSB in new radio (NR) release-17, the wireless communication device is configured to support a release version different from NR release-17, the wireless communication device is configured to support a PRACH configuration period larger than 160 ms, the wireless communication device is configured to support a preamble format, or the wireless communication device is configured to support a RA type.

The signaling may comprise at least one of a cell-specific downlink control information (DCI) signaling, a group-common DCI, a wireless communication device specific DCI, medium access control control element (MAC CE) signaling, radio resource control (RRC) signaling, or system information block (SIB) signaling. The cell-specific DCI may include information for one or more wireless communication devices in a cell that is used to indicate the at least one valid or available RA occasion for transmission of the PRACH signal. The group-common DCI may have DCI format 2_7 with cyclic redundancy check (CRC) scrambled by a radio network temporary identifier (RNTI), or DCI format 1_0 with CRC scrambled by a paging RNTI (P-RNTI), or DCI format 2_6 with CRC scrambled by power saving RNTI (PS-RNTI), or DCI format 2-0, 2-1, 2-2, 2-3, 2-4 or 2-5, or a defined DCI format to include information of the at least one valid or available RA occasion for transmission of the PRACH signal. The wireless communication device specific DCI may have DCI format 0-1, 0-2, 1-1 or 1-2 or a defined DCI format to include information of the at least one valid or available RA occasion for transmission of the PRACH signal.

The wireless communication device may further determine a number of contention-based RA preambles per SSB index per valid RA occasion according to a result of dividing a total number of RA preambles by number of SSB indexes, wherein at least one of the following is satisfied: the number of contention-based RA preambles per SSB index per valid RA occasion is equal to the result, the result rounded up to a nearest integer, or the result rounded down to a nearest integer, the total number of RA preambles is indicated via a downlink control information (DCI) signaling, or the total number of RA preambles is larger or smaller than a most recently configured number of SSB indexes associated with one RA occasion.

If a SSB in new radio (NR) release-17, or a SSB new to a SSB in NR release-17, is configured for the wireless communication device, the wireless communication device may determine at least one of: that the SSB new to a SSB in NR release-17 is selected with higher priority than the SSB in NR release-17, for each valid RA occasion, or at least one defined parameter for PRACH transmission associated with the SSB new to a SSB in NR release-17. The at least one defined parameter may be configured to indicate a threshold of a synchronization signal reference signal received power (SS-RSRP) associated with the SSB new to a SSB in NR release-17.

The wireless communication device may determine a number of contention-based preambles mapped to each enhanced SSB index according to a result of a total number of contention based preambles configured by the defined parameter divided by the enhanced SSB index. The number of contention based preambles mapped to each enhanced SSB index may be equal to the result, the result rounded up to a nearest integer, or the result rounded down to a nearest integer, or the result rounded to a nearest integer.

When an enhanced SSB is configured or a number of enhanced SSB indices is configured, or the enhanced SSB is configured for 2-step RA type, a defined number of SSBs mapped to each RA occasion for 2-step RA type and a defined number of contention-based RA preambles mapped to each SSB are used for each enhanced SSB, or a parameter for enhanced SSB is configured to indicate a number of SSB indices mapped to each PRACH occasion for 2-step RA type and a number of contention-based RA preambles mapped to each SSB index.

A parameter for enhanced SSB may be configured to indicate a number of contention-based RA preambles for 2-step RA type mapped to each SSB, when PRACH occasions are shared between 2-step and 4-step RA types. The wireless communication device may be configured to support a SSB different from a SSB in new radio (NR) release-17.

At least one aspect is directed to a system, method, apparatus, or a computer-readable medium. A wireless communication node may transmit, to a wireless communication device, first information in a signaling indicative of a pattern of at least one physical random access channel (PRACH) or downlink (DL) signal transmission. The wireless communication node may receive, from the wireless communication device, a PRACH signal corresponding to a DL signal index in a random access (RA) occasion determined by the pattern.

The systems, devices, methods and computer-readable media described herein include a novel signal transmission/reception approaches. Specifically, the systems, devices, methods and computer-readable media described herein leverage the impact of downlink (DL) signaling on the uplink UL random access procedure to ensure UE's initial access performance and network energy saving without increasing UE power and degrading UE experience.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 shows a flow chart illustrating an example signal transmission method performed by a user equipment or wireless communication device, in accordance with some embodiments of the present disclosure;

FIG. 4 shows a flow chart illustrating an example signal reception method performed by a base station or wireless communication node, in accordance with some embodiments of the present disclosure;

FIG. 5 shows a diagram illustrating an example scenario where a number of random access (RA) occasions (ROs) occurring before a paging occasion (PO) are available for PRACH signal transmission, in accordance with some embodiments of the present disclosure;

FIG. 6 shows a diagram illustrating an example scenario where a number of ROs occurring after a PO are available for PRACH signal transmission, in accordance with some embodiments of the present disclosure;

FIG. 7 shows a diagram illustrating an example scenario where a number of ROs associated with four SSBs which are located before a PO are available for PRACH signal transmission, in accordance with some embodiments of the present disclosure;

FIG. 8 shows a diagram illustrating an example scenario where a number of ROs associated with three SSBs which are located before a PO are available for PRACH signal transmission, in accordance with some embodiments of the present disclosure; and

FIG. 9 shows a diagram illustrating an example mapping relationship from SSB to preambles for RA, in accordance with some embodiments of the present disclosure.

### DETAILED DESCRIPTION

### I. Mobile Communication Technology and Environment

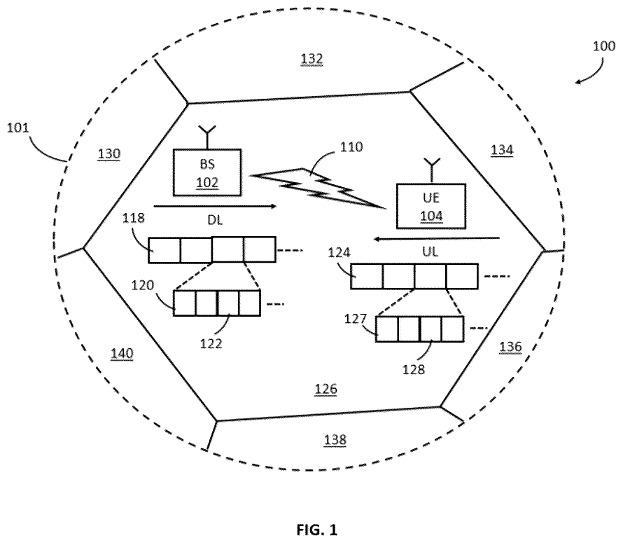

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

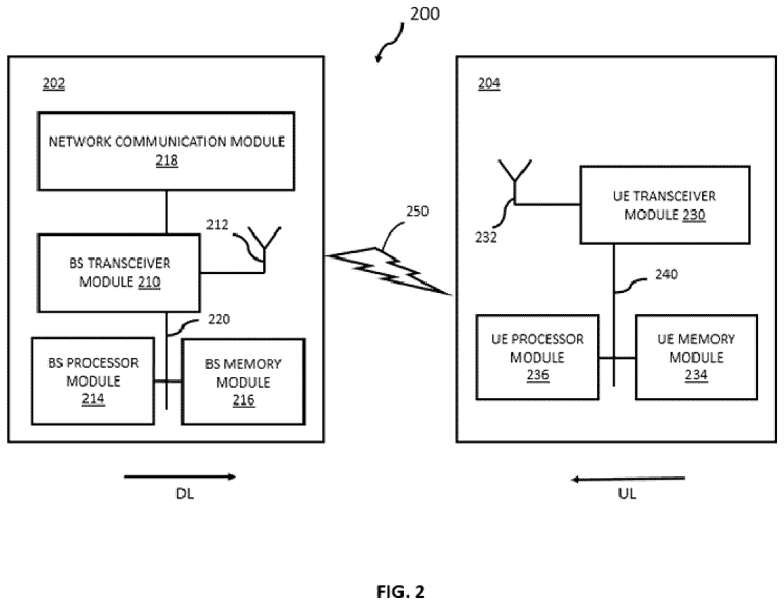

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### II. Systems and Methods for Signal Transmission

In 5G NR, there are some always-on signals which may cost power even though these signals are transmitted with a long periodicity, e.g., the maximum periodicity of 160 milliseconds (ms), during micro-sleep TX (transmit, transmission or transmitter) in a low traffic load scenario. According to actual implementations, most of the transmissions are unnecessary. Therefore, solutions for signal transmission enhancement are needed to achieve lower power consumption.

Currently, 5G devices have been significantly deployed so that the coverage shall be provided by 5G carrier frequency only for both DL (downlink) and UL (uplink). It is observed that the UL coverage of 5G is less than that of 4G system because the UL carrier frequency of 5G is different than that of 4G. Efficient UL transmission enhancement can also obtain potential energy saving so the solutions for UL coverage enhancement need to be provided as well.

Switch to sleep mode or turn off some RF components when they are not needed are effective methods to reduce network power consumption. For example, if there is no UE access, the carrier can be deactivated. When the traffic load is low, the number of Tx/Rx antennas can be reduced.

However, there are some problems with this energy saving method. First, there are some common signals and necessary transmissions in NR, for example the SSB (Synchronization Signal Block), SIB1 (System Information Block), paging, and PRACH (Physical Random Access Channel) reception. Therefore, the network cannot easily enter the low power consumption state, e.g., the sleep mode. Secondly, even if the devices can enter sleep states, it is a problem to wake up the devices. If semi-static configuration is used, the devices can be awakened only after sleeping for a period of time. If there is service requirement in sleeping states, it cannot meet the requirement, which will cause great delay and affect user experience.

To sum up, to reduce power consumption of communication systems, the network should be able to enter the low power consumption state as long as possible. In addition, a more dynamic wake-up mechanism should be introduced to meet the flexible service requirements and minimize the impact on user experience. Obviously, UEs can be involved in this procedure to achieve better results.

Solutions on impacts of a DL (downlink) signal on UL (uplink) random access procedure are disclosed to ensure UE's initial access performance and network energy saving without increasing UE power and degrading UE experience. Specifically, embodiments described herein allow the base station to control the number and timing of random access (RA) occasions (ROs) and signal such information to UEs. From the UEs side, knowing about available or valid ROs allows them to more efficiently manage or use the sleep mode or low-power consumption modes. Also, the UEs can more reliably perform initial access when knowing the timing of available or valid ROs.

As used herein, including in the claims, “or” as used in a list of items (e.g., a list of items prefaced by a phrase such as “at least one of” or “one or more of”) indicates an inclusive list such that, for example, a list of at least one of A, B or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In this disclosure, the base station (BS) may mean that a communication node, or BTS (Base Transceiver Station) in 2G, or NodeB in 3G, or eNB (E-UTRAN NodeB/enhanced NodeB) in 4G, or gNB in 5G, or a base station of LTE (Long term evolution) or NR (New Radio access technology), or a base station of further generation communication system, or a cell with a normal state or activated state or deactivated state or dormant state, or a cell providing basic coverage, or a cell boosting capacity, or a small cell, or a primary cell, or a secondary cell.

A SSB represents a DL signal with a transmission mechanism new to NR Rel-17, or an enhanced DL signal based on existing DL signal in NR Rel-17. An SSB also includes or means at least one of the following: a reduced number of SSB during an SSB periodicity, an SSB periodicity which is larger than the maximum value of SSB periodicity in NR Rel-17, a small SSB which occupies less time and frequency domain resource than the normal SSB in NR Rel-17, or an SSB with larger periodicity configuration from the normal SSB in NR Rel-17, or PSS or SSS, TRS, CSI-RS, CD-SSB, NCD-SSB (non cell-defined SSB), inter-band SCell without SSB.

As used herein, a SSB new to a SSB in NR release-17 comprises at least one of a small SSB in size which occupies less time and frequency domain resources than the normal SSB in NR Rel-17 compared to the SSB(s) defined in NR release-17 or a SSB with a larger periodicity compared to the SSB in NR release-17. The larger periodicity can be an integer that is equal to 2β*10 ms where β can be larger than 4.

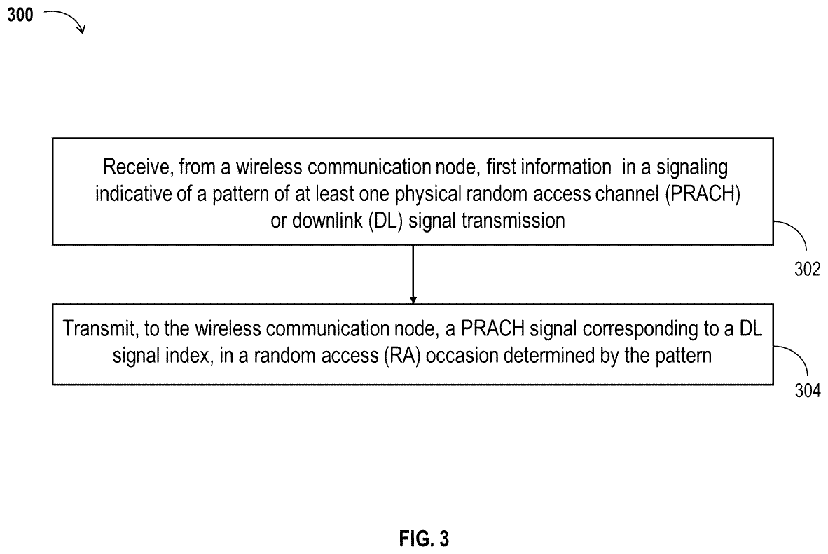

Referring now to FIG. 3, a flow chart illustrating an example signal transmission method 300 performed by a user equipment or wireless communication device 104 or 204, in accordance with some embodiments of the present disclosure. The wireless communication device 104 or 204 can receive, from a wireless communication node 102 or 202, first information in a signaling indicative of a pattern of at least one physical random access channel (PRACH) or downlink (DL) signal transmission. The wireless communication device 104 or 204 can transmit, to the wireless communication node 102 or 202, a PRACH signal corresponding to a DL signal index, in a random access (RA) occasion determined by the pattern.

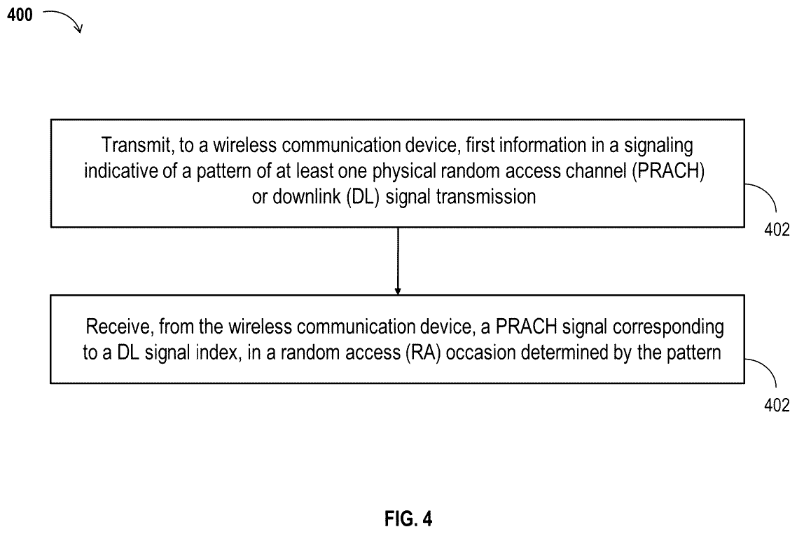

Referring now to FIG. 4, a flow chart illustrating an example signal reception method 400 performed by the wireless communication node 102 or 202, in accordance with some embodiments of the present disclosure. The wireless communication node 102 or 202 can transmit, to the wireless communication device 104 or 204, first information in a signaling indicative of a pattern of at least one physical random access channel (PRACH) or downlink (DL) signal transmission. The wireless communication node may receive, from the wireless communication device 104 or 204, a PRACH signal corresponding to a DL signal index in a random access (RA) occasion determined by the pattern. The method 400 can be viewed as analogous to the method 300, but performed by the wireless communication node 102 or 202.

The methods 300 and 400 are described in further detail in relation with (1) the pattern of the availability of RA occasion, (2) mapping relationship from SSB to the availability of RA occasion, (3) mapping relationship from SSB to preambles for RA, and (4) UE features related to the availability of RA occasion, which are discussed below.

### Determining the Availability or Validity of RA Occasions

One question is how to determine the availability or validity of RA occasion(s) for transmission of PRACH signals or other UL signals. The RA occasion(s) available or valid for PRACH signal or other UL signal transmission can follow a predefined or specified pattern. As used herein, availability or validity of an RA occasion implies that the RA occasion can be used by the wireless communication device 104 or 204 to transmit PRACH or other uplink signals.

The pattern of the availability or validity of RA occasion(s) can be defined or determined according to at least one of the following:

\textcircled{1} Paging occasion information: UE can assume that a number of RA occasion(s) associated with a paging occasion are available. The number of RA occasion(s) can be equal to n. For example, UE 104 or 204 can assume that RA occasion(s) located or occurring after a paging occasion are available for transmission of a PRACH signal or other UL signal. UE 104 or 204 can assume that RA occasion(s) which are not located after a paging occasion are not available for transmission of a PRACH signal or other UL signal. According to another example, UE 104 or 204 can assume that RA occasion(s) located or occurring before a paging occasion are available. UE 104 or 204 can assume that RA occasion(s) which are not located before a paging occasion are not available for transmission of a PRACH signal or other UL signal.

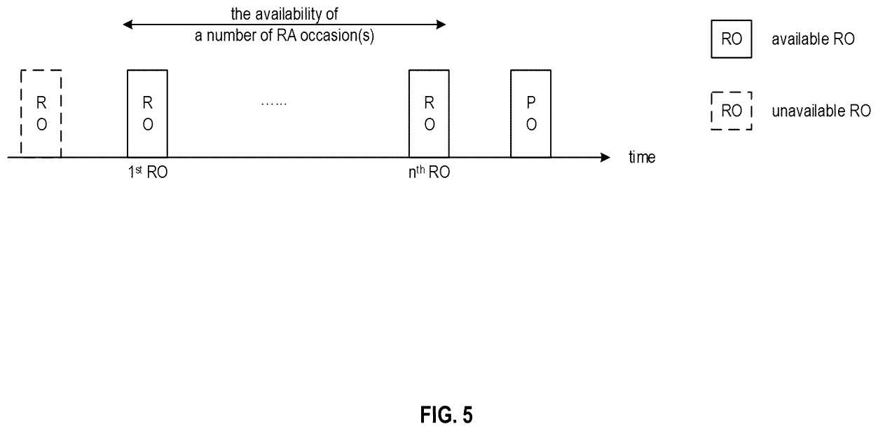

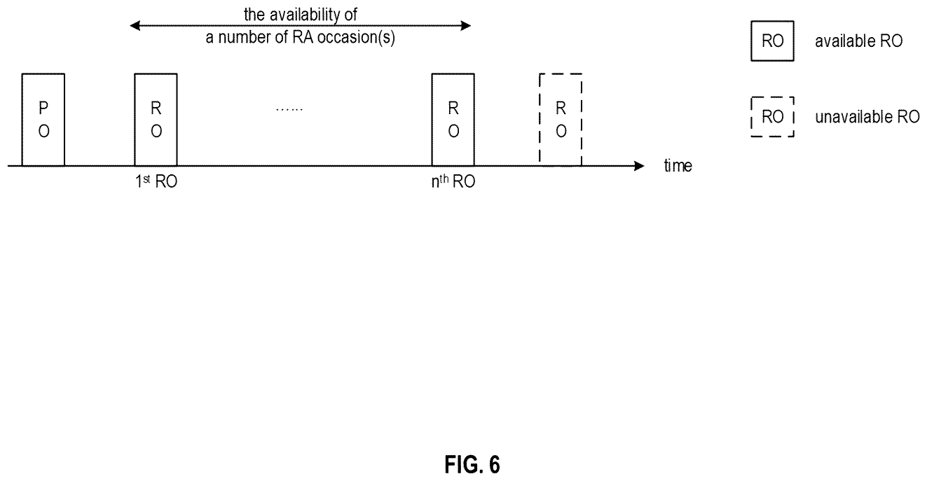

FIG. 5 shows an example scenario where n RA occasions (ROs) occurring before a paging occasion (PO) are available for the transmission of a PRACH signal or other UL signal. FIG. 6 shows an example scenario where n ROs occurring after a paging occasion are available for the transmission of a PRACH signal or other UL signal. The ROs shown in continuous lines represent available or valid ROs, while ROs shown in dashed lines represent non-available or non-valid ROs.

\textcircled{2} SSB information: UE 104 or 204 can assume that a number of RA occasion(s) associated with a number of SSBs are available for PRACH signal (or other UL signal) transmission. The number of SSBs can be located before a paging occasion. The number of RA occasion(s) can be located after the paging occasion.

UE 104 or 204 can assume that a number of RA occasion(s) associated with a number of SSBs which are located before a paging occasion are available for PRACH signal (or other UL signal) transmission and the number of RA occasion(s) are located after the paging occasion. UE 104 or 204 can assume that RA occasion(s) which are not associated with the number of SSBs located before the paging occasion are not available for PRACH signal (e.g., RA preamble) or other UL signal transmission even if the RA occasion(s) are located after the paging occasion.

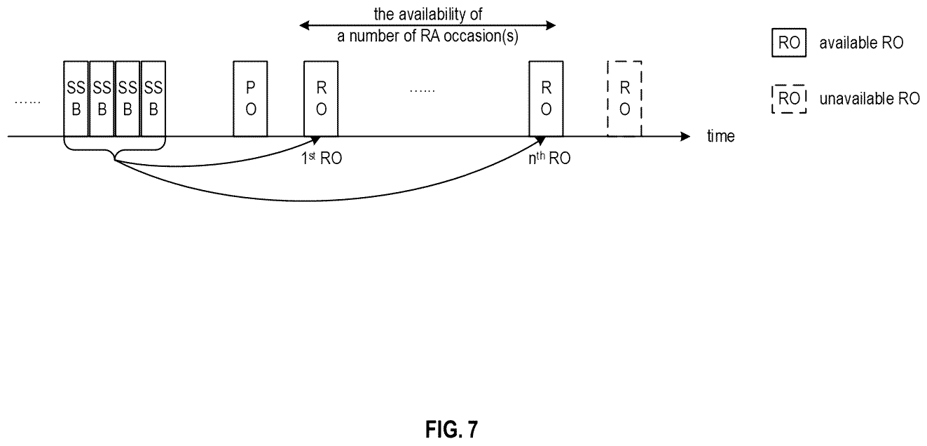

FIG. 7 illustrates an example scenario where a number of ROs associated with four SSBs which are located before a PO are available or valid for PRACH signal or other uplink signal transmission. The four SSBs are located before the PO, while the n ROs associated with the four SSBs (shown in continuous lines) are located after the PO. The RO shown in dashed line is not associated with any of the four SSBs, and as such, is unavailable or non-valid for PRACH signal transmission.

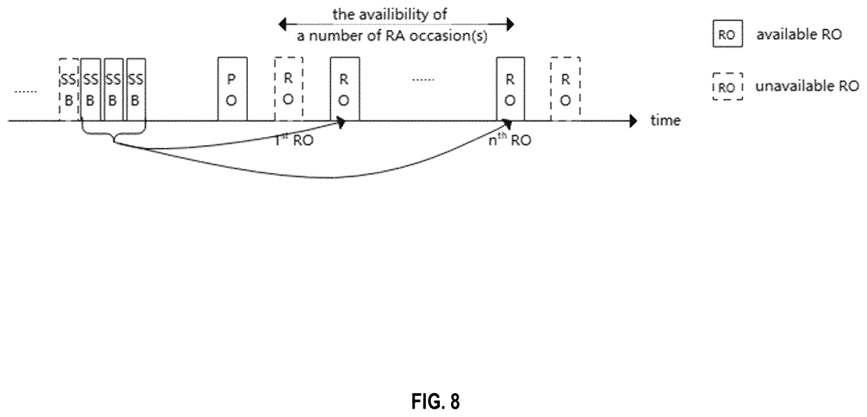

FIG. 8 illustrates a scenario where a number of ROs associated with three SSBs which are located before a PO are available or valid for PRACH signal transmission, in accordance with some embodiments of the present disclosure. The relevant SSBs with respect to the availability or validity of the ROs are the three SSBs shown in continuous lines. There are n ROs associated with the three SSBs and available or valid for PRACH signal transmission. The SSBs are located before the PO, while the n ROs associated with the three SSBs (shown in continuous lines) are located after the PO. The ROs shown in dashed line are not associated with any of the three SSBs, and as such, are unavailable or non-valid for PRACH signal transmission.

In some implementations, the paging occasion (PO) information or SSB information used to determine the availability of RA occasion(s) are indicated or used for idle-mode UE.

\textcircled{3} A number of RA occasions: UE 104 or 204 can assume that a number of RA occasion(s) occurring or located during a specific resource are available or valid for PRACH signal or RA preamble(s) transmission. The specific resource can be defined by the PRACH transmission parameters including PRACH preamble format, time resources, and frequency resources for PRACH transmission.

\textcircled{4} PRACH configuration period: UE can assume that a number of RA occasion(s) that are available or valid for PRACH signal (or RA preamble) transmission are determined by a PRACH configuration period. For instance, In some implementations, the PRACH configuration period is not larger than 320 ms or is not smaller than 10 ms.

According to a first example, the maximum value of PRACH configuration period can be larger than 160 ms, e.g., for the cases of SCS configuration=15 KHz for FR1 or SCS configuration=60 KHz for FR2,

In some implementations of the first example, the maximum value of a PRACH configuration index configured by higher layer signaling is not less than M (e.g. 262) and not larger than M+α*n, wherein n is the number of PRACH configuration periods that are larger than 160 ms. M can be an integer in the range of 0˜262. The parameter α can be any value in the range of 1-11. The value of a PRACH configuration period which is larger than 160 ms can be configured for FR1. The value of PRACH configuration period which is larger than 160 ms can be configured for at least one of the following Preamble format: 0, 1, 2, 3, A1, A2, A3, B4, C0 or C2. The value of PRACH configuration period that is larger than 160 ms can be or can include 320 ms, and the maximum value of PRACH configuration index configured by higher layer parameter can be a value in the range of 263˜273.

In some implementations of the first example, the maximum value of PRACH configuration index configured by higher layer signaling is not less than M (e.g. 255) and not larger than M+α*n, wherein n is the number of PRACH configuration period that is larger than 160 ms. M can be an integer in the range of 0˜255. The parameter α can be any value in the range of 1-19. The value of PRACH configuration period which is larger than 160 ms can be configured for FR2. The value of PRACH configuration period which is larger than 160 ms can be configured for at least one of the following Preamble format: A1, A2, A3, B1, B4, C0, or C2, A1/B1, A2/B2 or A3/B3. The value of PRACH configuration period that is larger than 160 ms can be or can include 320 ms, and the maximum value of PRACH configuration index configured by higher layer parameter can be a value in the range of 255˜274.

\textcircled{5} An association period: An association period is or represents a (configured) number of PRACH configuration periods. The time duration of an association period is equal to the PRACH configuration period multiplied by the number of PRACH configuration periods in the association period. The configured value of an association period (or the unit of association periods) represents the number of PRACH configuration periods within the association period, e.g., 1, 2, 4, 8, 16. The maximum time duration of an association period can be a constant value (e.g. 160 ms), so that an association period is determined by (or limited by) the value of a PRACH configuration period. The value of an association period can be determined by as the maximum duration of the association period divided by the PRACH configuration period. An association period, which is starting from frame 0, for mapping SSB indexes to PRACH occasions is the smallest value in the set determined by the PRACH configuration period.

According to a first example, for the case of a PRACH configuration period=x, the number of PRACH configuration periods during an association period is at least one of an integer in a predefined set, wherein the integer in the predefined set is not less than n1 and not larger than n2. The value x in the unit of ms can be an integer that is not smaller than min_x and not larger than max_x, wherein min_x is not larger than 10 or max_x is not smaller than 160. In some implementations, n1 is not larger than 1 and n2 is not less than

$$\frac{max\_x}{min\_x} .$$

For example, max_x can be an integer and is equal to 2^{β}*10 ms, wherein β is larger than 4.

In some implementations, max_x=320 ms, min_x=10 ms, for PRACH configuration period =10 ms, the candidate values of an association period can be at least one of the 1, 2, 4, 8, 16 or 32. n1=1, n2-32. In some implementations, max_x=640 ms, min_x=10 ms, for PRACH configuration period=20 ms, the candidate values of an association period can be at least one of the 1, 2, 4, 8, 16 or 32. n1=1, n2=64. In some implementations, max_x=1280 ms, min_x=10 ms, for PRACH configuration period =40 ms, the candidate values of an association period can be at least one of the 1, 2, 4, 8, 16 or 32. n1=1, n2=128. In some implementations, max_x=2560 ms, min_x=10 ms, for PRACH configuration period =80 ms, the candidate values of an association period can be at least one of the 1, 2, 4, 8, 16 or 32. n1=1, n2=256. In some implementations, max_x=640 ms, min_x=320 ms, for PRACH configuration period=320 ms, the candidate values of an association period can be 1 or 2. n1=1, n2=2. In some implementations, max_x=640 ms, min_x=320 ms, for PRACH configuration period=640 ms, the candidate values of an association period can be at least one of the 1. n1=1, n2=2.

\textcircled{6} An association pattern period: An association pattern period can include one or more association periods and can be determined so that a pattern between PRACH occasions and SSB indices repeats at most every max_x or min_x*n2. PRACH occasions not associated with SSB indices after an integer number of association periods, are not used for PRACH transmissions.

\textcircled{7} A validity duration for a number of RACH occasion: UE can assume that RA occasion(s) during a validity duration are valid or can be used for PRACH transmission.

\textcircled{8} A (configured) number of valid/available PRACH configuration periods: UE 104 or 204 can assume that RA occasion(s) during or within a number of configured valid or available PRACH configuration periods can be used for PRACH transmission.

\textcircled{9} A time duration for a (configured) number of valid or available PRACH configuration periods: UE 104 or 204 can assume that RA occasion(s) within a PRACH configuration period during the time duration can be used for PRACH transmission.

\textcircled{10} A number of available association periods: UE 104 or 204 can assume that RA occasion(s) during a number of availability of association period can be used for PRACH transmission.

(11) A time duration for a number of availability of association period: UE 104 or 204 can assume that RA occasion(s) during an association period (or during a configured or predefined time duration) can be used for PRACH transmission.

(12) An offset: UE 104 or 204 can assume that a number of RA occasion(s) which is/are located after a start position determine by an offset are available or valid for PRACH signal transmission.

(13) A start position for the time duration of RACH occasion: UE 104 or 204 can assume that a number of RA occasion(s) which is/are located after the start position are available or valid for PRACH signal transmission. In some examples, UE 104 or 204 can assume that the number of RA occasion(s) which are located after the start position are available. The start position can be determined by at least one of the position/SFN/slot index of the paging occasion, the paging cycle/eDRX cycle where the paging occasion is located, the number of SSB, the first RA occasion mapping with the number of SSB after the paging occasion, the time duration, an offset, or SIB or DCI carrying the indication information associated with the pattern of the availability of RA occasion(s).

The wireless communication node (or base station) 102 or 202 can send to the wireless communication device (or UE) 104 or 204 indication information for the availability or validity of RA occasions(s). The indication information can indicate to the UE 104 or 204 how to identify RA occasions available or valid for PRACH signal transmission. The indication information sent by the base station 102 or 2002 and received by the UE 104 or 204 can include at least one of the items in \textcircled{1} -(13).

Triggering or signaling the indication of available or valid RA occasions can be achieved in various ways. The indication information related to the availability (validity) of RA occasions for PRACH transmission can be indicated by at least one of the following signalings:

a. Cell-specific DCI: a DCI carrying the information for all of the UEs in a Cell can be used to indicate or signal the indication information related to availability of RACH occasion for PRACH transmission to UEs. The CRC of cell-specific DCI is scrambled by P-RNTI, SI-RNTI, TC-RNTI, or RA-RNTI:

a) The information field can be designed according to at least one of the following approaches:

i. one information block in a DCI can be configured (e.g., by base station 102 or 202) for the availability of RACH occasion for PRACH transmission indication for a cell or a cell group. The number of blocks may not larger than the number of cells or cell groups configured by higher layer parameter, or can be equal to 1. The starting position of a block can be determined by parameters configured by higher layers for one or more cells or cell groups.

ii. Bitmap field in a DCI can be configured for the availability of RACH occasion(s) for PRACH transmission indication for one or more cells or cell groups. The bit width of the bitmap field can be 0 bit if higher layer parameter associated with availability of RACH occasion for PRACH transmission is not configured, otherwise N bits bitmap determined according to the number of cells or the number of groups of cells provided by higher layer parameter. Each bit can correspond to one cell or one cell group(s) configured by higher layer parameters.

iii. one indication field in a DCI can be configured for the availability of RACH occasion for PRACH transmission indication in a cell.

b) A group of cells can be configured by base station 102 or 202. The cells supporting the same eDRX parameters or default paging cycle or DRX cycle can be configured in a cell group. The cell can be a SCell, an activated SCell, a dormant SCell, or a PCell.

The UE 104 or 204 can assume that the SCS configuration for PRACH transmission in a valid RACH occasion is the same for a group of cells.

b. Group-common DCI: the DCI format 2_7 with CRC scrambled by an RNTI, or the DCI format 1_0 with scrambled by P-RNTI, or the DCI format 2_6 with CRC scrambled by PS-RNTI, or the DCI format 2-0, 2-1, 2-2, 2-3, 2-4, 2-5, or a DCI format new to Rel-17 DCI format can be used to carry the indication information for availability of RACH occasion for PRACH transmission. The field of indication information can be designed according to at least one of the followings:

a) If an existing Rel-17 DCI format is used to indicate the indication information associated with availability of RACH occasion for PRACH transmission or the higher layer parameters associated with PRACH transmission is configured for the group of UE, the existing information field(s) or a new information field is used to indicate information associated with availability of RACH occasion for PRACH transmission. The existing fields can include at least one of:

i. the ‘Slot format indicator’ or Available RB set Indicator or COT duration indicator or Search space set group switching flag in DCI format 2_0 with CRC scrambled by SFI-RNTI;

ii. Pre-emption indication in DCI format 2_1 with CRC scrambled by INT-RNTI;

iii. Fields in DCI format 2_2 with CRC scrambled by TPC-PUSCH-RNTI or TPC-PUCCH-RNTI or DCI format 2_3 with CRC scrambled by TPC-SRS-RNTI, or DCI format 2_4 with CRC scrambled by CI-RNTI, or DCI format 2_5 with CRC scrambled by AI-RNTI;

iv. Fields of ‘Wake-up indication’ or ‘SCell dormancy indication’ in a block in DCI format 2_6 with CRC scrambled by PS-RNTI;

v. Paging indication field or TRS availability indication in DCI format 2_7 with CRC scrambled by PEI-RNTI.

b) The UE group can be determined or defined based on at least one of the following:

i. the UE identity of the UE in a group is configured by higher layer parameters;

ii. a number of group of UE is configured by higher layer parameters;

iii. the UE with the valid PO in a same PF or in a number of sequential PF during an eDRX cycle or a default paging cycle is configured as a UE group.

c) The information field in the DCI can indicate one or more UEs according to at least one of the following processes:

i. one information block in a DCI is configured for a UE in the UE group.

ii. One information block in a DCI is configured for a group of UE.

iii. A bit in a bitmap in a DCI is configured for one or more groups of UEs.

c. UE-specific DCI: the existing DCI format 0-1 or DCI format 0-2, or DCI format 1-1 or DCI format 1-2 or a new DCI can be used to carry the indication information for availability of RACH occasion for PRACH transmission.

a) The one indication field in a DCI can be configured for the availability of RACH occasion for PRACH transmission indication for the UE.

i. The indication field is a bitmap to indicate the availability of one or more validity duration or periodicity for availability of RACH occasion for PRACH transmission;

ii. The indication field can be an n-bit field to indicate the reference point or start SFN/slot/symbol for validity duration or the availability of RACH occasion for PRACH transmission;

b) existing information field can be used to indicate the indication information related to availability of RACH occasion for PRACH transmission. The existing information field can include at least one of the following:

i. The field of ‘Frequency domain resource assignment’, ‘Time domain resource assignment’, ‘Modulation and coding scheme’, ‘New data indicator’, ‘Redundancy version’, ‘HARQ process number’, or ‘UL/SUL indicator’ in DCI format 0_0 with CRC scrambled by C-RNTI or CS-RNTI or MCS-C-RNTI;

ii. ‘HARQ-ACK bitmap’ or ‘All the remaining bits’ used for indicating CG-DFI, ‘Frequency domain resource assignment’, ‘Time domain resource assignment’, ‘Modulation and coding scheme’, ‘New data indicator’, ‘Redundancy version’, ‘HARQ process number’, or ‘UL/SUL indicator’ in DCI format 0_1 with CRC scrambled by C-RNTI or CS-RNTI or SP-CSI-RNTI or MCS-C-RNTI;

iii. ‘Frequency domain resource assignment’, ‘Time domain resource assignment’, ‘Modulation and coding scheme’, ‘New data indicator’, ‘Redundancy version’, ‘HARQ process number’, or ‘UL/SUL indicator’ in DCI format 0_2 with CRC scrambled by C-RNTI or CS-RNTI or SP-CSI-RNTI or MCS-C-RNTI;

iv. ‘Random Access Preamble index’, ‘UL/SUL indicator’, ‘SS/PBCH index’, ‘PRACH Mask index’, ‘Reserved bits’, ‘Time domain resource assignment’, ‘Modulation and coding scheme’, ‘New data indicator’, ‘Redundancy version’, ‘HARQ process number’, ‘Downlink assignment index’, ‘PUCCH resource indicator’, ‘Short Messages’ or ‘TRS availability indication’ in DCI format 1_0 with CRC scrambled by C-RNTI or CS-RNTI or MCS-C-RNTI;

v. ‘Frequency domain resource assignment’, ‘Time domain resource assignment’, ‘Modulation and coding scheme’ for transport block 1, ‘New data indicator’ for transport block 1, ‘Redundancy version’ for transport block 1, ‘HARQ process number’, ‘PDSCH group index’, or ‘HARQ-ACK retransmission indicator’, or ‘SCell dormancy indication’ in DCI format 1_1 or DCI format 1_2 with CRC scrambled by C-RNTI or CS-RNTI or MCS-C-RNTI.

d. MAC CE: MAC CE can be used to indicate the indication information. For example, information including activation/start of availability of RACH occasion or the deactivation/stop of availability of RACH occasion or the change of availability of RACH occasion for PRACH transmission.

e. RRC signaling: the parameters of availability of RACH occasion for PRACH transmission can include at least one of the following:

a) The indication information for availability of RACH occasion for PRACH transmission mentioned above;

b) The parameters of availability of RACH occasion for PRACH transmission configured for a cell or a group of cell;

c) The parameters of availability of RACH occasion for PRACH transmission configured for a UE or a group of UEs.

f. SIB: If the UE is configured with supporting PRACH transmission, the UE shall acquire SIB information during the valid modification period.

a) The UE can assume that the modification period for SIB acquisition is the modification period n after the modification period n-1 that the indication of SI change was received or is the modification period according to the mechanisms specified in NR Rel-17.

i. Wherein the availability of RACH occasion for PRACH transmission during the modification period n+1 is available for the UE if the information carried by SIB indicates the start or availability of RACH occasion for PRACH transmission. If the SIB acquired by UE does not carry the indication information for valid RACH occasion for PRACH transmission, UE assumes that the RACH occasion for PRACH transmission is stopped or is not started or is unavailable.

b) Indication information carried by SIB can include at least one of the following:

i. PRACH Configuration Index;

ii. The availability of one or more validity duration of RACH occasion for PRACH transmission;

iii. The availability of one or more RACH occasion;

iv. The parameters associated with RACH occasions;

V. The number of RB or OFDM symbol occupied by RACH occasion for PRACH transmission;

vi. The periodicity or duration for RACH occasion for PRACH transmission;

vii. The start offset for validity duration or periodicity for RACH occasion for PRACH transmission;

viii. The start position or reference point for validity duration or for valid RACH occasion;

ix. Whether the availability period of valid RACH occasion for PRACH transmission is configured/started/stopped or not;

X. Whether the RACH occasion for PRACH transmission is valid or not;

g BS interaction: If the UE is configured with supporting the indication of availability of RACH occasion, the information associated with the PRACH transmission can be interacted or exchanged between the BS and other peer BSs or neighbor BSs. The interaction information can include at least one of the following:

a) Whether availability of RACH occasion for PRACH transmission is supported by a Serving Cell or not can be interacted among wireless communication nodes through Xn interface;

b) Whether availability of RACH occasion for PRACH transmission is supported by a group of UE or not can be interacted among wireless communication nodes through Xn interface.

c) Xn interface supports the exchange of signaling information between two NG-RAN nodes, and the forwarding of PDUs to the respective tunnel endpoints.

h. Events: If the UE is configured with availability of RACH occasion for PRACH transmission, the availability of RACH occasion for PRACH transmission is triggered by an event. The event includes at least one of the following:

a) Events on BS side triggering availability of RACH occasion for PRACH transmission include at least one of the following:

i. BS receives request for availability of RACH occasion for PRACH transmission sent by UE.

ii. BS receives the acknowledgement information for availability of RACH occasion for PRACH transmission configuration by a number of UE wherein the number of UE is not smaller than 1, or is larger than a threshold; the threshold is equal to a multiple of the number of idle-mode UEs or connected-mode UEs in a cell; wherein the multiple is a fraction and is larger than 0.

iii. A Serving Cell is configured with DTX;

iv. The value of RSRP/RSRQ reported by one or more UEs is lower than a threshold;

v. The load percent is smaller than a threshold;

vi. The DL or UL data volume is smaller than a threshold;

b) Events on UE side triggering availability of RACH occasion for PRACH transmission can include at least one of the following:

i. UE reports the acknowledgement for availability of RACH occasion for PRACH transmission configuration;

ii. UE's DL transmission is restricted on a serving cell;

iii. UE does not need to perform PDCCH monitoring for a duration;

iv. measurement results based on SSB or CSI-RS or TRS or PTRS or PRS resource are smaller than a threshold;

v. measurement results of RSRP/RSRQ are larger than a threshold;

vi. The associated SSB and CSI-RS resource configured by higher layer parameters are quasi co-located for a UE.

vii. RRC configurations or reconfigurations including indication information associated with availability of RACH occasion for PRACH transmission include at least one of the following:

1. The indication information for availability of RACH occasion for PRACH transmission mentioned above;

2. The modification period;

3. The Serving Cell ID or Serving Cell group ID for supporting availability of RACH occasion for PRACH transmission.

c) A timer is introduced for availability of RACH occasion for PRACH transmission. When the timer is expired, the availability of RACH occasion for PRACH transmission is stopped or started.

Determining the Mapping Relationship from DL Signals to the Availability of RA Occasions

The mapping relationship from DL signals to the availability of RA occasion can be determined by the UE or defined by the base station according to at least one of the following:

\textcircled{1} An association pattern period can include one or more association periods and can be determined so that a pattern between PRACH occasions and SSB indexes repeats at most every max_x or min_x*n2. PRACH occasions not associated with SSB indexes after an integer number of association periods, are not used for PRACH transmissions.

\textcircled{2} If the periodicity of SSB T^{SSB} is larger than the maximum value of an association pattern period or an association period or a PRACH configuration period or 160 ms,

1) an association pattern period can include one or more association periods and is determined so that a pattern between PRACH occasions (or RO) and SSB indexes repeats at most every T^{SSB}. PRACH occasions not associated with SSB indexes after an integer number of association periods, are not used for PRACH transmissions; or

2) An association pattern period can include one or more association periods and is determined so that a pattern between PRACH occasions and SSB indexes repeats at most every max_x or min_x*n2. PRACH occasions not associated with SSB indices after an integer number of association periods, are not used for PRACH transmissions; or

3) An association pattern period can include one or more association periods and is determined so that a pattern between PRACH occasions and SSB indexes repeats at most every 160 ms. PRACH occasions not associated with SSB indexes after an integer number of association periods, are not used for PRACH transmissions.

In some embodiments, the SSB can be an SS/PBCH block in NR Rel-17 or an SSB with a larger periodicity or a smaller SSB.

\textcircled{3} If a base station (BS) or UE is configured with discontinuous transmission (DTX), PRACH occasions associated with SSB indexes during the time duration of DTX state are not used for PRACH transmissions.

In some implementations, the cases that PRACH configuration period is larger than

160 ms, or min_x or max_x is larger than 160 ms can be triggered by at least one of the following events:

a) the wireless communication device is configured to support a SSB different from a SSB in new radio (NR) release-17 by a signaling; or

b) the wireless communication device is configured to support a release version different from NR release-17 by a signaling; or

c) the wireless communication device is configured to support a PRACH configuration period larger than 160 ms by a signaling; or

d) the wireless communication device is configured to support a preamble format by a signaling; or

e) the wireless communication device is configured to support a RA type by a signaling.

f) Wherein the signaling can be a higher layer parameter or UE capability.

Determining the Mapping Relationship from DL Signals to Preambles for PRACH Transmission

The mapping relationship from DL signals to preambles for RA can be determined or defined as described below.

A first technical problem for the mapping relationship from SSB to preambles for RA can be disclosed as follows. Assume that:
the total number of contention based (CB) preambles given by totalNumberOfRA-Preambles or msgA-TotalNumberOfRA-Preambles is noted as N_{preamble}^{total},
a number N_{SSB}^{RO} of SS/PBCH block indexes associated with one PRACH occasion given by SSB-per-rach-occasion configured by ssb-perRACH-OccasionAndCB-PreamblesPerSSB or msgA-SSB-PerRACH-OccasionAndCB-PreamblesPerSSB,
a number R of contention based preambles per SS/PBCH block index per valid PRACH occasion given by CB-preambles-per-SSB configured by ssb-perRACH-OccasionAndCB-PreamblesPerSSB or msgA-SSB-PerRACH-OccasionAndCB-PreamblesPerSSB,
a number Q of contention based preambles per SS/PBCH block index per valid PRACH occasion given by CB-preambles-per-SSB configured by msgA-CB-PreamblesPerSSB-PerSharedRO,
a number of SSB index N^{SSB} during an SSB periodicity.

Therefore, N_{preamble}^{RO}=R or Q×max(1, N_{SSB}^{RO}) and N_{preamble}^{total} is the multiple of N_{SSB}^{RO}. A first issue is that for the case of a number of SS/PBCH block indices associated with one PRACH occasion N_{SSB}^{RO}=8, when the number of SSB index (e.g., 4) during an SSB periodicity is dynamically indicated by a DCI or a L1 signaling and is smaller than the last recent number of SSB index (e.g., 8), the number of CB preambles per SSB index per valid PRACH occasion N_{preamble}^{SSB_index} for the reduced 4 SSB indexes is not used for PRACH transmission. Therefore, if the number of CB preambles per SSB index per valid PRACH occasion N_{preamble}^{SSB_index} for the reduced 4 SSB indices can be reused for the existing 4 SSB indices for PRACH transmission, the access probability shall be improved and the energy consumption can be saved simultaneously. For example, there can be 256 preambles that are available for a RA occasion and 4 SSB indices associated with a RA occasion configured by higher layer parameters. Namely, there can be 64 preambles per SSB index per RA occasion. But if the number of available SSB indices per RA occasion is changed into 2 dynamically, there is still 64 preambles per SSB index per RA occasion and the remaining (256−64*2) preambles are wasted obviously. However if the number of preambles per SSB index per RA occasion is changed to 128,UEs requesting initial access are not easy to collide with each other comparing with 64 preambles per SSB index per RA occasion, especially, when a large number of UEs requesting initial access in a serving cell.

A second issue is that for the case of a number of SS/PBCH block indexes associated with one PRACH occasion N_{SSB}^{RO}=8, when the number of SSB index (e.g., 16) during a SSB periodicity is dynamically indicated by a DCI or an L1 signaling and is smaller than the last recent number of SSB index (e.g., 8), the number of CB preambles per SSB index per valid PRACH occasion N_{preamble}^{SSB_index} for the increased 8 SSB indexes are not assigned for PRACH transmission. It shall decrease the access probability, especially when the best SSB index is one of the increased 8 SSB indexes based on the SSB measurement by UE.

Solutions for the mapping relationship between SSB and contention based preambles for RA can be described as following:

\textcircled{1} the number of contention-based Random Access Preambles per SS/PBCH block index per valid PRACH occasion can be determined by at least one of the following methods:

1) If the number of SSB index N_{SSB} during an SSB periodicity is indicated by a DCI or is larger than or smaller than the last recent configured number of SS/PBCH block indexes N_{SSB}^{RO} associated with one PRACH occasion, the number of contention based preambles per SS/PBCH block index per valid PRACH occasion is determined by function (N_{preamble}^{total}/N_{SSB}), wherein function(⋅) represents that rounding up, rounding down or rounding or retaining the original input value of ⋅ wherein N_{SSB} and N_{SSB}^{RO} are integers and N_{SSB}^{RO} is not smaller than 1.

a. function (N_{preamble}^{total}/N_{SSB}) contention based preambles with consecutive indexes associated with SSB index n, 0≤n≤N_{SSB}−1, per valid PRACH occasion start from preamble index n*N_{preamble}^{total}/N_{SSB}, or from n*N_{preamble}^{total}/N_{SSB}+R.

b. In some embodiments, the last recent configured number of SS/PBCH block indexes N_{SSB}^{RO} associated with one PRACH occasion is the last recent configuration or given by SSB-per-rach-occasion configured by ssb-perRACH-OccasionAndCB-PreamblesPerSSB or msgA-SSB-PerRACH-OccasionAndCB-PreamblesPerSSB.

2) If the number of SSB index N_{SSB} during an SSB periodicity is indicated by a DCI or is equal to the last recent configured number of SS/PBCH block indexes N_{SSB}^{RO} associated with one PRACH occasion, the number of contention based preambles per SS/PBCH block index per valid PRACH occasion is R or Q.

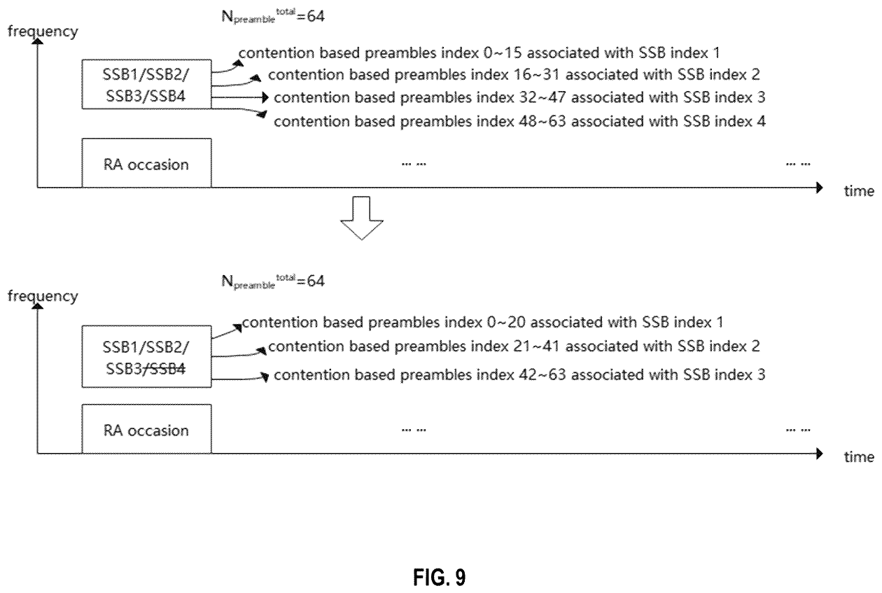

FIG. 9 shows a diagram illustrating an example mapping relationship from SSB to preambles for RA, in accordance with some embodiments of the present disclosure.

A second technical problem 2 for the mapping relationship from SSB to preambles for RA can be described as follows:

When an SSB in NR Rel-17, or a small SSB or an SSB with larger periodicity used for NR Rel-18 are configured for the UE, the selected type/kind of SSB associated with PRACH occasion should be determined in order to eliminate the ambiguity on the usage of SSB associated with PRACH occasion between BS and UE.

Solutions to the parameters associated with the type of SSB except for SSB in NR Rel-17 for PRACH procedure can be described as follows:

1 If an SSB in NR Rel-17 or a small SSB or an SSB with larger periodicity are configured for the UE, the UE can assume that:

1) a small SSB or an SSB with larger periodicity are selected with higher priority than an SSB in NR Rel-17 per valid PRACH occasion; or

2) new parameter(s) for PRACH transmission associated with the type of selected SSB (except for SSB in NR Rel-17) is/are introduced where:

a. For example, a new parameter indicates the number of SSB which is new to SSB in NR Rel-17 (e.g., a small SSB or an SSB with larger periodicity) associated with a valid PRACH occasion.

b. For example, a new parameter indicates the number of contention-based Random Access Preambles associated with an SSB which is new to SSB in NR Rel-17 per valid PRACH occasion.

c. For example, new parameters for RA procedure initialization associated with SSB which is new to SSB in NR Rel-17.

d. For example, new parameter indicates the threshold of the SS-RSRP associated with the SSB which is new to SSB in NR Rel-17. In some embodiments, if SSB new to SSB in NR Rel-17 is configured, the rsrp-threshold used for RACH procedure associated with the SSB new to SSB in NR Rel-17 is determined based on the following: if rsrp-ThresholdEnhancedSSB is configured by RRC, rsrp-ThresholdEnhancedSSB is used as rsrp-threshold; else if rsrp-ThresholdSSB for 4-step RA or msgA-RSRP-ThresholdSSB for 2-step RA is configured by RRC, rsrp-ThresholdSSB or msgA-RSRP-ThresholdSSB is used as rsrp-threshold for 4-step or 2-step RACH procedure respectively; else enhanced SSB cannot be selected for the RACH procedure.

e. In some embodiments, the new parameters are used for NR Rel-18; or

3) Current RACH procedure shall be ignored or canceled,

a. when at least one of the following conditions are met: a cell is switching from DTX active time to outside DTX active time or a cell is switching from a normal state to an ES state, and a current RACH procedure is ongoing.

b. when at least one of the following conditions are met: a cell is switching from DTX active time to outside DTX active time or a cell is switching from a normal state to an ES state, and a current RACH procedure is ongoing, except for at least one of the following conditions:

a) PREAMBLE_TRANSMISSION_COUNTER is greater than 0; or

b) LBT failure indication is not received from lower layers for this Random Access Preamble transmission or for the transmission of this MSGA RA Preamble; or

c) this is the first MSGA transmission within this Random Access procedure; or

d) the Random Access Preamble or MSGA RA Preamble is transmitted.

c. In some embodiments, the current RACH procedure is performing the RA preamble transmission.

4) Once the Random Access Preamble is transmitted and regardless of the possible occurrence of a measurement gap, if a cell is switching from DTX active time to outside DTX active time or a cell is switching from a normal state to an ES state, and if a current RACH procedure is ongoing, the current RACH procedure shall be ignored or canceled except for at least one of the following conditions:

a. the contention-free Random Access Preamble for beam failure recovery request was transmitted by the MAC entity; or

b. MAC entity is monitoring the PDCCH of the SpCell for Random Access Response(s) identified by the RA-RNTI while the ra-ResponseWindow is running; or MAC entity is monitoring the PDCCH of the SpCell for Random Access Response identified by the MSGB-RNTI or C-RNTI while the msgB-ResponseWindow is running; or

C. the ra-ResponseWindow configured in BeamFailureRecoveryConfig at the PDCCH occasion is running; or

d. notification of a reception of a PDCCH transmission on the search space indicated by recoverySearchSpaceId is received from lower layers on the Serving Cell where the preamble was transmitted; or notification of a reception of a PDCCH transmission of the SpCell is received from lower layers; or

e. ra-ResponseWindow configured in BeamFailureRecoveryConfig expires and a PDCCH transmission on the search space indicated by recoverySearchSpaceId addressed to the C-RNTI has not been received on the Serving Cell where the preamble was transmitted; or

f. ra-ResponseWindow configured in RACH-ConfigCommon expires, and the Random Access Response containing Random Access Preamble identifiers that matches the transmitted PREAMBLE_INDEX has not been received; or

g a valid downlink assignment has been received on the PDCCH for the MSGB-RNTI and the received TB is successfully decoded.

Embodiments for methods 1) and 2) are disclosed as follows:

1. Parameters of ssb-perRACH-OccasionAndCB-PreamblesPerSSB or msgA-SSB-PerRACH-OccasionAndCB-PreamblesPerSSB are used for SSB new to SSB in NR Rel-17. In the following, the SSB except for or new to SSB in NR Rel-17 is noted as enhanced SS/PBCH block or enhanced SSB.

a. N_{SSB}^{RO} configured by any of the parameters is not larger than N_{SSB}.

b. If N_{SSB}^{RO} configured by any of the parameters is larger than N_{SSB}, or if N_{SSB}^{RO}<1, N_{SSB} is used as the number of SSBs mapped to each PRACH occasion for RACH procedure, i.e., one enhanced SS/PBCH block index is mapped to 1/N_{SSB}^{RO} consecutive valid PRACH occasions and R contention based preambles with consecutive indexes associated with the enhanced SS/PBCH block index per valid PRACH occasion start from preamble index 0.

c. If N_{SSB}^{RO} configured by any of the parameters is larger than N_{SSB}, or if N_{SSB}^{RO}≥21, or if N_{preamble}^{total} is an integer multiple of N_{SSB}, N_{SSB} is used as the number of SSBs mapped to each PRACH occasion for RACH procedure, i.e., R contention based preambles with consecutive indexes associated with enhanced SS/PBCH block index n, 0≤n≤N_{SSB}−1, per valid PRACH occasion start from preamble index n*N_{preamble}^{total}/N_{SSB}.

d. If N_{SSB}^{RO} configured by any of the parameters is larger than N_{SSB}, or if N_{SSB}^{RO}≥1, or if N_{preamble}^{total} is not an integer multiple of N_{SSB}, N_{SSB} is used as the number of SSBs mapped to each PRACH occasion for RACH procedure, and R contention based preambles with consecutive indexes associated with enhanced SS/PBCH block index n, 0≤n≤N_{SSB}−1, per valid PRACH occasion start from preamble index function (n*N_{preamble}^{total}/N_{SSB}), function represents rounding down, rounding up or rounding the input value to an integer.

e. If N_{SSB}^{RO} configured by any of the parameters is larger than N_{SSB}, or if N_{SSB}^{RO}≤1, or if N_{preamble}^{total} is not an integer multiple of N_{SSB}, N_{SSB} is used as the number of SSBs mapped to each PRACH occasion for RACH procedure, and R contention based preambles with consecutive indexes associated with enhanced SS/PBCH block index n, 0≤n≤N_{SSB}−1, per valid PRACH occasion start from preamble index n*R−1 or n*R or n*R+1.

f. If N_{SSB}^{RO} configured by any of the parameters is larger than N_{SSB}, or if N≥1, or if N_{preamble}^{total} is not an integer multiple of N_{SSB}, or the multiplication of N_{SSB}^{RO} and R is not larger than N_{preamble}^{total}, N_{SSB} is used as the number of SSBs mapped to each PRACH occasion for RACH procedure, and R contention based preambles with consecutive indexes associated with enhanced SS/PBCH block index n, 0≤n≤N_{SSB}−1, per valid PRACH occasion start from preamble index n*R−1 or n*R or n*R+1.

If N_{SSB}^{RO} configured by any of the parameters is larger than N_{SSB}, or if N_{SSB}^{RO}≥1, or if N_{preamble}^{total} is not an integer multiple of N_{SSB}, N′ is used as the number of SSBs mapped to each PRACH occasion for RACH procedure, and R contention based preambles with consecutive indexes associated with enhanced SS/PBCH block index n, 0≤n≤N′−1, per valid PRACH occasion start from preamble index n*N_{preamble}^{total}/N′. Wherein N′ is a positive integer and is closest to and not larger than or is closest to and not smaller than or is closest to N_{SSB} among the integer values that N_{preamble}^{total} is an integer multiple of each of the integer values.

2. If enhanced SSB is configured, introduce new parameter to indicate the number of enhanced SSBs mapped to each PRACH occasion and the number of contention-based Random Access Preambles mapped to each SSB are used for enhanced SSB.

a. ssb-perRACH-OccasionAndCB-PreamblesPerSSB: defines the number of SSBs mapped to each PRACH occasion for 4-step RA type and the number of contention-based Random Access Preambles mapped to each SSB; or if enhanced SSB is configured and the number of enhanced SSBs is less than the number of SSBs, the defined number of SSBs mapped to each PRACH occasion for 4-step RA type is equal to the number of enhanced SSBs and the number of contention-based Random Access Preambles mapped to each SSB can be used for each enhanced SSBs or the number of contention-based Random Access Preambles mapped to each enhanced SSB is equal to the value of function (the number of SSBs configured by the parameter * the number of contention-based Random Access Preambles mapped to each SSBs configured by the parameter/the number of enhanced SSBs), wherein the function represents rounding up or rounding down or rounding the input value to an integer; or introduce a specific parameter for enhanced SSBs to define the number of enhanced SSBs mapped to each PRACH occasion for 4-step RA type and the number of contention-based Random Access Preambles mapped to each enhanced SSB;

b. msgA-SSB-PerRACH-OccasionAndCB-PreamblesPerSSB: defines the number of SSBs mapped to each PRACH occasion for 2-step RA type and the number of contention-based Random Access Preambles mapped to each SSB; or if enhanced SSB is configured or the number of enhanced SSBs is less than the number of SSBs, or enhanced SSB is configured for 2-step RA type, the defined number of SSBs mapped to each PRACH occasion for 2-step RA type and the defined number of contention-based Random Access Preambles mapped to each SSB are used for each enhanced SSB; or introduce a specific parameter for enhanced SSBs to define the number of SSBs mapped to each PRACH occasion for 2-step RA type and the number of contention-based Random Access Preambles mapped to each SSB;

3. When the Random Access procedure is initiated on a Serving Cell, parameters for RA procedure initialization associated with enhanced SSB should be introduced at least one of the following:

a. Wherein the Random Access procedure is initiated by a PDCCH order, by the MAC entity itself, or by RRC for the events in accordance with NR Rel-17 specification.

b. rsrp-ThresholdEnhancedSSB: an RSRP threshold for the selection of the enhanced SSB for 4-step RA type. If the Random Access procedure is initiated for beam failure recovery, rsrp-ThresholdEnhancedSSB used for the selection of the enhanced SSB within candidateBeamRSList refers to rsrp-ThresholdEnhancedSSB in BeamFailureRecoveryConfig IE;

c. rsrp-ThresholdCSI-RS: an RSRP threshold for the selection of CSI-RS for 4-step RA type. If the Random Access procedure is initiated for beam failure recovery, if enhanced SSB is configured, rsrp-ThresholdCSI-RS is equal to rsrp-ThresholdEnhancedSSB in

BeamFailureRecoveryConfig IE, else rsrp-ThresholdCSI-RS is equal to rsrp-ThresholdSSB in BeamFailureRecoveryConfig IE;

d. msgA-RSRP-ThresholdEnhancedSSB: an RSRP threshold for the selection of the enhanced SSB for 2-step RA type;

e. rsrp-ThresholdEnhancedSSB-SUL: an RSRP threshold for the selection between the NUL carrier and the SUL carrier if enhanced SSB is configured;

f. Offset is defined for msgA-RSRP-Threshold or rsrp-ThresholdMsg3 if enhanced SSB is configured, otherwise the offset does not configured or equal to 0;

g. candidateBeamRSList: a list of reference signals (CSI-RS and/or SSB and/or enhanced SSB) identifying the candidate beams for recovery and the associated Random Access parameters;

h. ra-ehancedSsb-OccasionMaskIndex: defines PRACH occasion(s) associated with an enhanced SSB in which the MAC entity may transmit a Random Access Preamble;

i. msgA-CB-PreamblesPerSSB-PerSharedRO: defines the number of contention-based Random Access Preambles for 2-step RA type mapped to each SSB when the PRACH occasions are shared between 2-step and 4-step RA types; or if enhanced SSB is configured or the number of enhanced SSBs is less than the number of SSBs, the number of contention-based Random Access Preambles for 2-step RA type mapped to each SSB is also used to be mapped to each enhanced SSB; or if enhanced SSB is configured or the number of enhanced SSBs is less than the number of SSBs, the number of contention-based Random Access Preambles for 2-step RA type mapped to each SSB is equal to 0, when the PRACH occasions are shared between 2-step and 4-step RA types; or introduce a specific parameter for enhanced SSBs to define the number of contention-based Random Access Preambles for 2-step RA type mapped to each SSB when the PRACH occasions are shared between 2-step and 4-step RA types;

j. if groupBconfigured is configured, then Random Access Preambles group B is configured for 4-step RA type. If enhanced SSB is configured, amongst the contention-based Random Access Preambles associated with an enhanced SSB, the first numberOfRA-PreamblesGroupA included in groupBconfigured Random Access Preambles belong to Random

Access Preambles group A. The remaining Random Access Preambles associated with the enhanced SSB belong to Random Access Preambles group B (if configured).

k. if groupB-ConfiguredTwoStepRA is configured, then Random Access Preambles group B is configured for 2-step RA type. If enhanced SSB is configured, amongst the contention-based Random Access Preambles for 2-step RA type associated with an enhanced SSB, the first numberOfRA-PreamblesGroupA included in GroupB-ConfiguredTwoStepRA Random Access Preambles belong to Random Access Preambles group A. The remaining Random Access Preambles associated with the enhanced SSB belong to Random Access Preambles group B (if configured).

1. If Random Access Preambles group B is supported by the cell and if enhanced SSB is configured, Random Access Preambles group B is included for each SSB or each enhanced SSB.

m. if Random Access Preambles group B is configured for 4-step RA type, and if enhanced SSB is configured, numberOfRA-PreamblesGroupA: defines the number of Random Access Preambles in Random Access Preamble group A for each SSB or each enhanced SSB included in groupBconfigured.

n. if Random Access Preambles group B is configured for 2-step RA type, and if enhance SSB is configured, numberOfRA-PreamblesGroupA: defines the number of Random Access Preambles in Random Access Preamble group A for each SSB or each enhanced SSB included in GroupB-ConfiguredTwoStepRA.

o. If enhanced SSB is configured, a specific set of parameters of ra-ResponseWindow, ra-ContentionResolutionTimer, msgB-ResponseWindow or ta-Report is configured by higher layers.

p. At least one of the following UE variables are used for the RA procedure when enhanced SSB is configured or enhanced SSB is selected for RA procedure:

a) PREAMBLE_INDEX for enhanced SSB;

b) REAMBLE_TRANSMISSION_COUNTER for enhanced SSB;

c) PREAMBLE_POWER_RAMPING_COUNTER for enhanced SSB;

d) PREAMBLE_POWER_RAMPING_STEP for enhanced SSB;

e) PREAMBLE_RECEIVED_TARGET_POWER for enhanced SSB;

f) PREAMBLE_BACKOFF for enhanced SSB;

g) PCMAX for enhanced SSB;

h) SCALING_FACTOR_BI for enhanced SSB;

i) RA_TYPE for enhanced SSB;

j) POWER_OFFSET_2STEP_RA for enhanced SSB;

k) MSGA_PREAMBLE_POWER_RAMPING_STEP for enhanced SSB.

q. If enhanced SSB is configured, the network configures the same value for rsrp-ThresholdEnhancedSSB-SUL in all BWPs. So, the UE can obtain this parameter from any Random Access configuration.

4. When the Random Access procedure is initiated on a Serving Cell, if enhanced SS is configured, or

a. if the BWP selected for RA procedure is configured with 2-step RA type RA Resources, or if the Random Access procedure was initiated for reconfiguration with sync and if the contention-free Random Access Resources for 2-step RA type have been explicitly provided in rach-ConfigDedicated for the BWP selected for Random Access procedure, the MAC entity shall set the RA_TYPE to 2-stepRA.

b. if the BWP selected for RA procedure is only configured with 4-step RA type RA Resources, the MAC entity shall set the RA_TYPE to 4-stepRA. The enhanced SSB shall not be selected for RA procedure.

5. If DTX or ES state are configured, the rsrp-ThresholdMsg3 is updated or adjusted based on the indication by L1 signaling. Wherein the L1 signaling is also used to indicate the information associated with DTX or ES state.

6. If contention-free Random Access Resources have not been provided for this Random Access procedure and if one or more of the features including Enhanced SSB or DTX or ES state is applicable for the RA procedure,

a. if none of the sets of Random Access resources are available for the current Random Access procedure, the MAC entity shall select the set of RA resources that are not associated with any feature indication; or

b. else if there are one or more set(s) of Random Access resources available and one of these set(s) of Random Access resources can be used for indicating all features triggering this Random Access procedure, the MAC entity shall select the available set of Random Access resources for this Random Access procedure; or

c. else (i.e., there are one or more sets of Random Access resources available that are configured with indication(s) for a subset of all features triggering the RACH procedure), the MAC entity shall select a set of Random Access resources from the available set of Random Access resources based on the priority order indicated in the system information for this Random Access Procedure.

7. For each set of configured Random Access resources for 4-step RA type and for each set of configured Random Access resources for 2-step RA type: if the features of Enhanced SSB or DTX or ES state indication are configured for a set of RA resources, the MAC entity shall consider the set of Random Access resources as not available for the RACH procedure which is not triggered for enhanced SSB or DTX or ES state, or if enhanced SSB or DTX or ES state indications are not applicable.

8. If the available sets of Random Access resources configured with Enhanced SSB or DTX or ES state indication are identified, the MAC entity shall select one set of RA resources among one or more sets of RA resources configured with the features applicable to the current RACH procedure. Wherein the one set of RA resources is configured with enhanced SSB; or the set of RA resources is configured with DTX; or the set of RA resources is configured with the current ES state or the target ES state.

9. If enhanced SSB is configured, the rsrp-threshold used for RACH procedure associated with the enhanced SSB is determined based on the following: if rsrp-ThresholdEnhancedSSB is configured by RRC, rsrp-ThresholdEnhancedSSB is used as rsrp-threshold; else if rsrp-ThresholdSSB for 4-step RA or msgA-RSRP-ThresholdSSB for 2-step RA is configured by RRC, rsrp-ThresholdSSB or msgA-RSRP-ThresholdSSB is used as rsrp-threshold for 4-step or 2-step RACH procedure respectively; else enhanced SSB cannot be selected for the RACH procedure. For example,

a. If the selected RA_TYPE is set to 4-stepRA, if the Random Access procedure was initiated for SpCell beam failure recovery; and if the beamFailureRecoveryTimer is either running or not configured; and if the contention-free Random Access Resources for beam failure recovery request associated with any of the enhanced SSBs have been explicitly provided by RRC; and if at least one of the enhanced SSBs with SS-RSRP above a rsrp-threshold amongst the enhanced SSBs in candidateBeamRSList is available, the MAC entity shall select an enhanced SSB with SS-RSRP above rsrp-threshold amongst the enhanced SSBs in candidateBeamRSList.

b. For 4-step RACH procedure, if the ra-PreambleIndex is not 0b000000, and if the contention-free Random Access Resources associated with enhanced SSBs have been explicitly provided by RRC and at least one enhanced SSB with SS-RSRP above rsrp-threshold amongst the associated enhanced SSBs is available, the MAC entity shall select an enhanced SSB with SS-RSRP above rsrp-threshold amongst the associated enhanced SSBs and set the PREAMBLE_INDEX to a ra-PreambleIndex corresponding to the selected enhanced SSB.

c. If the contention-free 2-step RA type Resources associated with enhanced SSBs have been explicitly provided by higher layer parameters and at least one enhanced SSB with SS-RSRP above rsrp-threshold amongst the associated SSBs is available, the MAC entity shall select an enhanced SSB with SS-RSRP above rsrp-threshold amongst the associated enhanced SSBs and set the PREAMBLE_INDEX to a ra-PreambleIndex corresponding to the selected enhanced SSB.

10. For 4-step RACH procedure, if the ra-PreambleIndex is not 0b000000, and if enhanced SSB is configured, the MAC entity shall select the enhanced SSB signaled by PDCCH. If the enhanced SSB does not signaled by PDCCH, the MAC entity shall select the SSB signaled by PDCCH.

11. If enhanced SSB or SSB are configured, if at least one of the enhanced SSBs with SS-RSRP above rsrp-threshold and at least one of the SSBs with SS-RSRP above rsrp-ThresholdSSB for 4-step RACH or above msgA-RSRP-ThresholdSSB for 2-step RACH are available, the enhanced SSB shall be selected; or if at least one of the enhanced SSBs with SS-RSRP above rsrp-threshold is available, an enhanced SSB with SS-RSRP above rsrp-threshold shall be selected; or if none of enhanced SSBs above rsrp-threshold and none of the SSBs with SS-RSRP above rsrp-ThresholdSSB for 4-step RACH or above msgA-RSRP-ThresholdSSB for 2-step RACH, the MAC entity shall select any SSB. For example,

a. For 4-step RACH, if the Random Access Resources for SI request have been explicitly provided by RRC, if at least one of the enhanced SSBs with SS-RSRP above rsrp-threshold and SSBs with SS-RSRP above rsrp-ThresholdSSB are available, the MAC entity shall select an enhanced SSB with SS-RSRP above rsrp-threshold.

b. for the contention-based Random Access preamble selection, if at least one of the enhanced SSBs with SS-RSRP above rsrp-threshold is available, the MAC entity shall select an enhanced SSB with SS-RSRP above rsrp-threshold.

12. For 4-step RACH, in the association period given by ra-AssociationPeriodIndex in the si-RequestPeriod, if enhanced SSB and SSB are permitted by the restrictions given by the ra-enhancedSsb-OccasionMaskIndex or ra-ssb-OccasionMaskIndex if configured, an enhanced SSB shall be selected.

13. For 2-step RACH, to determine if there is an enhanced SSB with SS-RSRP above msgA-RSRP-ThresholdSSB or msgA-RSRP-ThresholdEnhancedSSB, the UE uses the latest unfiltered L1-RSRP measurement.

14. If DTX or ES state is configured, and the BWP during the time duration of outside DTX active time or keeping ES state in a serving cell is not associated with any SSB, SS-RSRP measurement is performed based on the SSB associated with the BWP of another serving cell indicated by higher layer parameters.

### UE Features

UE 104 or 204 can include features related to the availability of RA occasion(s). The UE 104 or 204 can include feature(s) related to support of PRACH transmission associated with SSB new to SSB in NR Rel-17.

In the cases of empty and low resource utilization, common signal transmission, e.g., SSB or SIB, occupies a large portion on time domain. According to system-level simulation, if SSB or SIB transmission can be limited, BS can obtain amount of energy saving benefits. When SSB new to SSB in NR Rel-17 are configured, UE can perform PRACH transmission during a valid RACH occasion associated with the SSB new to SSB in NR Rel-17.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module”), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

We claim:

1. A method comprising:
receiving, by a wireless communication device from a wireless communication node, first information in a signaling indicative of a pattern of at least one physical random access channel (PRACH) or downlink (DL) signal transmission; and
transmitting, by the wireless communication device to the wireless communication node, a PRACH signal corresponding to a DL signal index, in a random access (RA) occasion determined by the pattern.

2. The method of claim 1, wherein the first information comprises at least one of:
information of at least one paging occasion,
information of at least one synchronization signal block (SSB),
an indication of a number of RA occasions,
an indication of a PRACH configuration period,
an indication of an association period, the association period comprising a configured number of PRACH configuration periods,
an indication of an association pattern period,
an indication of a validity duration for a number of RACH occasions,
an indication of a configured number of valid or available PRACH configuration periods,
an indication of a time duration for the configured number of valid or available PRACH configuration periods,
an indication of a time duration for a number of valid or available association periods,
an indication of an offset to indicate a start position of a RA occasion, or
an indication of a start position of at least one of the validity duration for the number of RACH occasions, the time duration for the configured number of valid or available PRACH configuration periods, the time duration for the number of valid or available association periods, a PRACH occasion, the PRACH configuration period, the association period or the association pattern period.

3. The method of claim 2, wherein at least a portion of the first information is used to determine at least one valid or available RA occasion for transmission of the PRACH signal.

4. The method of claim 2, wherein the PRACH configuration period satisfies at least one of:
the PRACH configuration period is at most max_x milliseconds (ms) or at least min_x ms in length, wherein at least one of min_x is not larger than 10 or max_x is not smaller than 160 is satisfied; or
a maximum value of a PRACH configuration index configured by higher layer signaling is not less than M and not larger than M+α*n, wherein M is a positive integer, n is a number of PRACH configuration periods that are each larger than 160 ms, and
α is a value in a first range of 1 to 11, and the PRACH configuration period is configured for at least one of following preamble format: 0, 1, 2, 3, A1, A2, A3, B4, C0 or C2; or
α is a value in a second range of 1 to 19, and the PRACH configuration period is configured for at least one of following preamble formats: A1, A2, A3, B1, B4, C0, or C2, A1/B1, A2/B2 or A3/B3.

5. The method of claim 2, wherein at least one of:
the configured number of PRACH configuration periods is an integer in a defined set that is not less than n1 and not larger than n2,
the PRACH configuration period (x) in milliseconds (ms) is an integer that is not smaller than min_x and not larger than max_x, wherein min_x is not larger than 10 or max_x is not smaller than 160, or
n1 is not larger than 1 and n2 is not less than
$$\frac{max\_x}{min\_x} .$$

6. The method of claim 5, wherein the association pattern period includes one or more association periods, and is determined so that a pattern between RA occasions and SSB indexes repeats at most every:
max_x or min_x*n2, or
T^{SSB}, where T^{SSB} is a periodicity of a SSB and is larger than a maximum value of the association pattern period or the association period or the PRACH configuration period, or larger than 160 ms, and
wherein PRACH occasions not associated with SSB indices after an integer number of association periods, are not used for PRACH transmission.

7. The method of claim 6, wherein the SSB comprises:
one or more synchronization signal and physical broadcast channel (SS/PBCH),
a SSB with a large periodicity, or
a small SSB.

8. The method of claim 4, wherein cases where the PRACH configuration period is larger than 160 ms, or min_x or max_x is larger than 160 ms are triggered by at least one of the following events:
the wireless communication device is configured to support a SSB different from a SSB in new radio (NR) release-17; or
the wireless communication device is configured to support a release version different from NR release-17; or
the wireless communication device is configured to support a PRACH configuration period larger than 160 ms; or
the wireless communication device is configured to support a preamble format; or
the wireless communication device is configured to support a RA type.

9. The method of claim 1, wherein the signaling comprises at least one of:
a cell-specific downlink control information (DCI) signaling, which includes information for one or more wireless communication devices in a cell that is used to indicate at least one valid or available RA occasion for transmission of the PRACH signal,
a group-common DCI, having DCI format 2_7 with cyclic redundancy check (CRC) scrambled by a radio network temporary identifier (RNTI), or DCI format 1_0 with CRC scrambled by a paging RNTI (P-RNTI), or DCI format 2_6 with CRC scrambled by power saving RNTI (PS-RNTI), or DCI format 2-0, 2-1, 2-2, 2-3, 2-4 or 2-5, or a defined DCI format to include information of the at least one valid or available RA occasion for transmission of the PRACH signal,
a wireless communication device specific DCI, having DCI format 0-1, 0-2, 1-1 or 1-2 or a defined DCI format to include information of the at least one valid or available RA occasion for transmission of the PRACH signal,
medium access control control element (MAC CE) signaling,
radio resource control (RRC) signaling, or
system information block (SIB) signaling.

10. The method of claim 1, further comprising:
determining, by the wireless communication device, a number of contention-based RA preambles per SSB index per valid RA occasion, according to a result of dividing a total number of RA preambles by number of SSB indexes, wherein at least one of:
the number of contention-based RA preambles per SSB index per valid RA occasion is: the result, or the result rounded up to a nearest integer, or the result rounded down to a nearest integer;
the total number of RA preambles is indicated via a downlink control information (DCI) signaling, or
the total number of RA preambles is larger or smaller than a most recently configured number of SSB indexes associated with one RA occasion.

11. The method of claim 1, wherein if a SSB in new radio (NR) release-17, or a SSB new to a SSB in NR release-17, is configured for the wireless communication device, the method comprises:
determining, by the wireless communication device, at least one of:
that the SSB new to a SSB in NR release-17 is selected with higher priority than the SSB in NR release-17, for each valid RA occasion; or
at least one defined parameter for PRACH transmission associated with the SSB new to a SSB in NR release-17.

12. The method of claim 11, wherein the at least one defined parameter is configured to indicate a threshold of a synchronization signal reference signal received power (SS-RSRP) associated with the SSB new to a SSB in NR release-17.

13. The method of claim 1, further comprising:
determining, by the wireless communication device, a number of contention-based preambles mapped to each enhanced SSB index, according to a result of a total number of contention based preambles configured by a defined parameter divided by the enhanced SSB index, wherein:
the number of contention based preambles mapped to each enhanced SSB index is equal to the result, the result rounded up to a nearest integer, or the result rounded down to a nearest integer, or the result rounded to a nearest integer.

14. The method of claim 1, wherein:
when an enhanced SSB is configured or a number of enhanced SSB indices is configured, or the enhanced SSB is configured for 2-step RA type: a defined number of SSBs mapped to each RA occasion for 2-step RA type and a defined number of contention-based RA preambles mapped to each SSB are used for each enhanced SSB; or
a parameter for enhanced SSB is configured to indicate a number of SSB indices mapped to each PRACH occasion for 2-step RA type and a number of contention-based RA preambles mapped to each SSB index.

15. The method of claim 1, wherein a parameter for enhanced SSB is configured to indicate a number of contention-based RA preambles for 2-step RA type mapped to each SSB, when PRACH occasions are shared between 2-step and 4-step RA types, or wherein the wireless communication device is configured to support a SSB different from a SSB in new radio (NR) release-17.

16. A method comprising:
transmitting, by a wireless communication node to a wireless communication device, first information in a signaling indicative of a pattern of at least one physical random access channel (PRACH) or downlink (DL) signal transmission; and
receiving, by the wireless communication node from the wireless communication device, a PRACH signal corresponding to a DL signal index, in a random access (RA) occasion determined by the pattern.

17. The method of claim 16, wherein the first information comprises at least one of:
information of at least one paging occasion,
information of at least one synchronization signal block (SSB),
an indication of a number of RA occasions,
an indication of a PRACH configuration period,
an indication of an association period, the association period comprising a configured number of PRACH configuration periods,
an indication of an association pattern period,
an indication of a validity duration for a number of RACH occasions,
an indication of a configured number of valid or available PRACH configuration periods,
an indication of a time duration for the configured number of valid or available PRACH configuration periods,
an indication of a time duration for a number of valid or available association periods,
an indication of an offset to indicate a start position of a RA occasion, or
an indication of a start position of at least one of the validity duration for the number of RACH occasions, the time duration for the configured number of valid or available PRACH configuration periods, the time duration for the number of valid or available association periods, a PRACH occasion, the PRACH configuration period, the association period or the association pattern period.

18. An apparatus comprising:
at least one processor configured to implement a method comprising:
receiving, from a wireless communication node, first information in a signaling indicative of a pattern of at least one physical random access channel (PRACH) or downlink (DL) signal transmission; and
transmitting, to the wireless communication node, a PRACH signal corresponding to a DL signal index, in a random access (RA) occasion determined by the pattern.

19. The apparatus of claim 18, wherein the first information comprises at least one of:
information of at least one paging occasion,
information of at least one synchronization signal block (SSB),
an indication of a number of RA occasions,
an indication of a PRACH configuration period,
an indication of an association period, the association period comprising a configured number of PRACH configuration periods,
an indication of an association pattern period,
an indication of a validity duration for a number of RACH occasions,
an indication of a configured number of valid or available PRACH configuration periods,
an indication of a time duration for the configured number of valid or available PRACH configuration periods,
an indication of a time duration for a number of valid or available association periods,
an indication of an offset to indicate a start position of a RA occasion, or
an indication of a start position of at least one of the validity duration for the number of RACH occasions, the time duration for the configured number of valid or available PRACH configuration periods, the time duration for the number of valid or available association periods, a PRACH occasion, the PRACH configuration period, the association period or the association pattern period.

20. The apparatus of claim 18, wherein the signaling comprises at least one of:
a cell-specific downlink control information (DCI) signaling, which includes information for one or more wireless communication devices in a cell that is used to indicate at least one valid or available RA occasion for transmission of the PRACH signal,
a group-common DCI, having DCI format 2_7 with cyclic redundancy check (CRC) scrambled by a radio network temporary identifier (RNTI), or DCI format 1_0 with CRC scrambled by a paging RNTI (P-RNTI), or DCI format 2_6 with CRC scrambled by power saving RNTI (PS-RNTI), or DCI format 2-0, 2-1, 2-2, 2-3, 2-4 or 2-5, or a defined DCI format to include information of the at least one valid or available RA occasion for transmission of the PRACH signal,
a wireless communication device specific DCI, having DCI format 0-1, 0-2, 1-1 or 1-2 or a defined DCI format to include information of the at least one valid or available RA occasion for transmission of the PRACH signal,
medium access control control element (MAC CE) signaling,
radio resource control (RRC) signaling, or
system information block (SIB) signaling.
